(19) United States
(12) Patent Application Publication
(10) Pub. No.: US 2024/0284487 A1
(43) Pub. Date: Aug. 22, 2024

(54) METHODS AND SYSTEMS FOR SIMULTANEOUS MBS AND UNICAST RECEPTION

(71) Applicant: Samsung Electronics Co., Ltd., Suwon-si (KR)

(72) Inventors: Vinay Kumar SHRIVASTAVA, Bangalore (IN); Sangkyu BAEK, Suwon-si (KR); Sriganesh RAJENDRAN, Bangalore (IN)

(21) Appl. No.: 18/444,407

(22) Filed: Feb. 16, 2024

(30) Foreign Application Priority Data
Feb. 16, 2023 (IN) 202341010522
Jul. 21, 2023 (IN) 202341049449
Jan. 23, 2024 (IN) 202341010522

(51) Int. Cl. H04W 72/30; H04L 27/26; H04W 72/0453; H04W 72/51

(52) U.S. Cl. CPC H04W 72/30; H04L 27/26025; H04W 72/0453; H04W 72/51

(57) ABSTRACT

Embodiments disclosed herein relate to methods and systems for shared processing for simultaneous MBS and unicast reception. The methods disclose enhanced interest indication signaling for simultaneous MBS and unicast reception from one or more networks. The methods include receiving, from a primary cell (PCell) of a serving base station, a system information block (SIB) including information on a transmission of a MBS interest indication (MII) message for a MBS broadcast reception on a non-serving cell; in case a MII message setting condition associated with the non-serving cell is satisfied, setting a content of the MII message; and based on the information, transmitting, to the serving base station, the MII message.

### CROSS REFERENCE TO RELATED APPLICATIONS

This application is based on and claims priority under 35 U.S.C. § 119 to Indian Provisional Application Nos. 202341010522, filed Feb. 16, 2023 and 202341049449, filed Jul. 21, 2023, and Indian Non-Provisional application No. 202341010522, filed Jan. 23, 2024, the contents of which are incorporated herein by reference.

### BACKGROUND

### 1. Field

Embodiments disclosed herein relate to wireless communication networks, and more particularly to shared processing for simultaneous multicast and broadcast service (MBS) and unicast reception.

### 2. Description of Related Art

A user equipment (UE) can be associated with one or more cells, carriers, frequencies, bandwidth parts (BWPs), cell groups (for example, master cell group (MCG) or secondary cell group (SCG)), tracking areas (TAs), non-public networks (NPNs), public land mobile networks (PLMN), networks, subscriber identity modules (SIMs) and mobile network operators (MNOs) or simply, termed as operators.

A UE can receive one or more services (for example, unicast, multicast, broadcast services) on one or more networks/operators. Further, there may or may not be coordination across these networks/operators or there may not be uplink signaling with regards to broadcast reception (for example, broadcast reception in RRC_IDLE or RRC_INACTIVE states) and resultantly, the concerned network may not be aware about UE receiving such services like broadcast service.

For simplicity, at most two networks/operators are considered herein, without any loss of generality. In an example, consider a UE is receiving unicast service(s) on a network (NW A (operator A)) and is receiving broadcast service(s) on another network (NW B (operator B)). In this scenario, a NW A may not be aware about the UE receiving broadcast service(s) as this is either not signaled to the NW B (for example, the UE may be in RRC_IDLE or RRC_INACTIVE state) or even if it is signaled to the NW B, the NW B may not have any coordination with NW A. As a NW A is not aware about the UE receiving broadcast service(s) on a NW B and resultantly, some of the baseband resource (processing) capability of the UE are used up in supporting these service(s), the NW A may have wrong assessment/information of UE capabilities and wrongly configure the UE with the configurations which are not suitable. For example, the NW A may configure the UE with a full-fledged configuration (for example, a carrier aggregation configuration with maximum number of component carriers or serving cells or a dual connectivity) assuming full baseband resource capability and resultantly, the UE may not be able to support the configuration and/or will support not in optimum manner in terms of device or service performance and/or satisfactory user experience.

To generalize, there is a possibility that the UE receives unicast from the serving cell and MBS from the non-serving cell(s) pertaining to the same network or different network(s). Moreover, the networks may belong to the same or different operators. There is a need for the UE to inform the serving cell about the cell broadcast reception status on the non-serving cell(s), so as the serving cell can suitably configure the UE considering its available baseband resource capability.

Currently available methods and systems suffer from two short-comings. Firstly, such methods do not determine the frequencies of the interest that pertain to the at least one MBS session on the non-serving cell. Secondly, such methods do not address a scenario for the MBS Interest Indication (MII) reporting to the serving cell when the UE completely stops the broadcast reception on the non-serving cell, since the last transmission of the MII indicating UE is receiving or interested to receive broadcast on non-serving cell. Consequently, the serving cell is not aware about the increased baseband capability of the UE and does not reconfigure the UE.

Further, shared processing for simultaneous MBS broadcast and unicast reception is newly introduced feature for 5G NR in Rel18 eMBS WI. MII reporting procedure does not have any provision which provides information to the serving cell on the MBS broadcast service reception by the UE on the non-serving cell. Consequently, UE configuration on the serving cell is not optimum and therefore UE may suffer from low throughput or higher interference.

In a conventional system (for example, in LTE FeMBMS), when a UE is connected to a first network (and may be accessing unicast service) and a second network (where it is dedicatedly accessing broadcast service or receive-only mode service), the UE sends a MBMS interest indication message to the first network comprising of the frequency, the bandwidth and sub-carrier spacing parameters for the broadcast services being received on the second network. The first network assesses the processing capability of the UE getting consumed on the second network dedicated to broadcast based on the frequency, the bandwidth and sub-carrier spacing parameters.

However, in new systems, the assessment becomes quite difficult when the first network and the second network are 5G networks and the services being accessed on them are respectively the unicast services and the MBS broadcast services (given the 5G network is not fully dedicated to the broadcast services), unlike conventional system and is catering to a variety of services like unicast, multicast and broadcast with different and dynamic amounts of resources. Therefore, in this case, the first network cannot judge as to how much processing capability of the UE is getting consumed in accessing the broadcast services on the second network just based on the three afore-mentioned parameters.

Hence, there is a need in the art for solutions which will overcome the above mentioned drawback(s), among others.

The principal object of the embodiments herein is to disclose methods and systems for shared processing for simultaneous multicast and broadcast service (MBS) and unicast reception.

Another object of embodiments herein is to disclose methods and systems for enhanced interest indication signaling for simultaneous MBS and unicast reception from one or more networks.

Another object of embodiments herein is to disclose methods and systems for enhanced interest indication signaling aspects of MBS for new radio (NR), and a 5th generation radio access technology (RAT), wherein embodiments herein disclose how to signal the MII reporting to the network, when a UE is receiving broadcast and unicast simultaneously from one or more networks.

Another object of embodiments herein is to disclose methods and systems for managing UE capability signaling aspects of multicast broadcast services (MBS) for new radio (NR), a 5th generation radio access technology (RAT), wherein embodiments herein disclose how to signal the UE capability information and/or assistance information reporting to the network, when a UE is receiving broadcast and unicast simultaneously from two networks belonging to same or different operators.

Another object of embodiments herein is to disclose methods and systems for time domain-based utilization factor or implementation based factors consideration for MII reporting towards future standards or UE implementation solutions.

### SUMMARY

Accordingly, the embodiments herein provide a method for simultaneous multicast and broadcast service (MBS) and unicast reception. The method comprises receiving, by a user equipment (UE), unicast from at least one serving cell on a first network. The method comprises receiving, by the UE, at least one MBS service from at least one non-serving cell on a second network. The MBS service comprises at least one of an MBS multicast service and an MBS broadcast service. The MBS service further comprises one or more MBS session(s). The method further comprises deciding, by the UE, whether to report the MBS service reception from the non-serving cell to the serving cell in an MBS interest indication (MII) message, based on UE's interest in the MBS service from the non-serving cell. The method further comprises reporting, by the UE, the MII to the serving cell based on the decision.

Accordingly, the embodiments herein provide a UE that comprises a processor. The processor is configured to receive unicast from at least one serving cell on a first network. The processor is configured to receive at least one MBS service from at least one non-serving cell on a second network. The processor is configured to decide whether to report the MBS service reception from the non-serving cell to the serving cell in the MII message, based on UE's interest in the MBS service from the non-serving cell. The processor is further configured to report the MII to the serving cell based on the decision.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the following drawings. Embodiments herein are illustrated by way of examples in the accompanying drawings, and in which:

FIG. 1 illustrates a system for simultaneous MBS and unicast reception according to embodiments as disclosed herein;

FIG. 2 illustrates a method for simultaneous MBS and unicast reception according to embodiments as disclosed herein;

FIG. 3 illustrates a method for reporting the MBS service reception to the serving cell in the MII message according to embodiments as disclosed herein;

FIG. 4 illustrates a method for determining the frequency of interest for MII reporting for the MBS broadcast service reception on the non-serving cell according to embodiments as disclosed herein;

FIG. 5 illustrates a method for MII reporting for the MBS broadcast service reception on the non-serving cell according to embodiments as disclosed herein;

FIG. 6 illustrates a method for scaling a UE's processing capability for the MBS service reception on the non-serving cell and a UE's actual processing capability for the unicast reception on the serving cell according to embodiments as disclosed herein;

FIG. 7 illustrates an alternate method for scaling a UE's processing capability for the MBS service reception on the non-serving cell and a UE's actual processing capability for the unicast reception on the serving cell according to embodiments as disclosed herein; and

FIG. 8 illustrates a procedural flow for the simultaneous unicast and MBS broadcast reception according to embodiments as disclosed herein.

### DETAILED DESCRIPTION

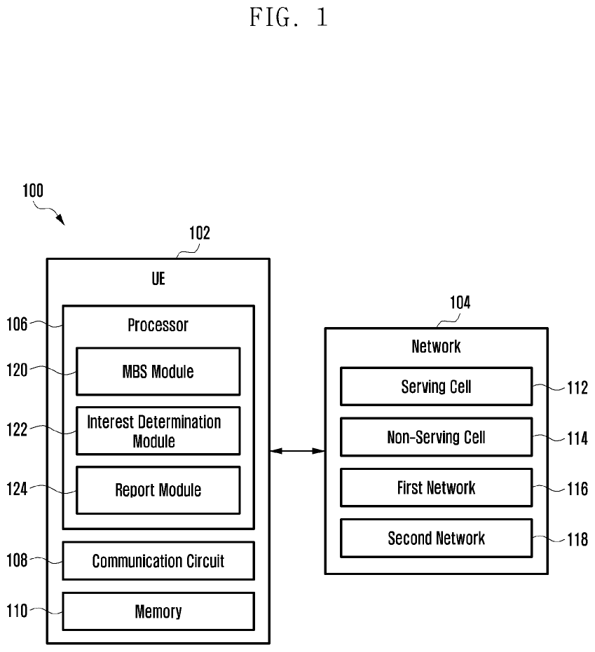

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising,” “having” and “including” are to be construed as open-ended terms unless otherwise noted.

The words/phrases “exemplary,” “example,” “illustration,” “in an instance,” “and the like,” “and so on,” “etc.,” “etcetera,” “e.g.,”, “i.e.,” are merely used herein to mean “serving as an example, instance, or illustration.” Any embodiment or implementation of the present subject matter described herein using the words/phrases “exemplary,” “example,” “illustration,” “in an instance,” “and the like,” “and so on,” “etc.,” “etcetera,” “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The embodiments herein achieve shared processing for simultaneous MBS and unicast reception using MII reporting procedure, where the MII provides information to the serving cell on the MBS broadcast service reception by a UE on the non-serving cell. Referring now to the drawings, and more particularly to FIGS. 1 through 8, where similar reference characters denote corresponding features consistently throughout the figures, there are shown embodiments.

Accordingly, the embodiments herein provide methods and systems for enhanced interest indication signaling aspects of MBS for NR, and a 5th generation RAT, wherein embodiments herein disclose how to signal the MII reporting to the network, when a UE is receiving broadcast and unicast simultaneously from one or more networks.

Examples of NR MBS services include:
Multicast services, for which the network transfers common user data that is intended to be received only by a specific group of UEs which have joined the concerned multicast group; and/or.
Broadcast services, for which the network transfers common user data that can be received by all UEs interested to receive the service.

The network may provide MBS services in a limited part of the network and coverage area of MBS services can be one cell or larger.

The 5G core network (CN) can deliver MBS user data to the radio access network (RAN) using following delivery methods:
Individual delivery: for each individual UE receiving the MBS service, CN delivers separate copies of the MBS user data packets to RAN (i.e., via per-UE PDU sessions, alike in case of unicast delivery); and/or.
Shared delivery: The CN delivers a single copy of MBS user data to RAN i.e., via a shared PDU session/tunnel), with RAN handling delivery to one or multiple UEs.

Beside MBS services, a UE may be engaged in unicast services also and in some scenarios, the UE can also avail unicast and MBS services from one or more networks belonging to the same or different networks. To generalize, embodiments herein consider that the UE receives unicast from serving cell and the UE receives MBS service from a non-serving cell belonging to the same or different networks.

In an embodiment herein, a UE may receive unicast on at least one serving cell on a first network and the UE may receive at least one MBS service (e.g., MBS broadcast) on at least one non-serving cell on a second network. The UE reports the MBS broadcast reception on the non-serving cell in the MII message to the serving cell. In another embodiment herein, the UE may report proactively the MII to the serving cell before the UE actually starts receiving the MBS service on the non-serving cell; for example, the UE is interested in the MBS broadcast service on non-serving cell, but the service has yet not started. In another embodiment herein, the UE may not report the MII to the serving cell when the unicast reception is not yet happening on the serving cell and the UE is receiving or interested to receive the MBS service on the non-serving cell.

In an embodiment herein, a UE receives at least one service or service set X on NW B in one of RRC_IDLE, RRC_INACTIVE and RRC_CONNECTED state, and at least one service or service set Y on NW A in RRC_CONNECTED state, then the UE triggers and sends a signaling message to NW A (and/or NW B) informing the UE baseband resource and/or processing capability information due to supporting service or service set Y on NW B (and/or NW A). The service or service set X on NW B can be at least one of unicast, multicast and broadcast services.

FIG. 1 illustrates a system 100 for simultaneous MBS and unicast reception. The system 100 provides information to a serving cell on the MBS broadcast service reception by the UE on a non-serving cell. The system 100 comprises a UE 102, and a network 104. The UE 102 further comprises a processor 106, a communication circuit 108 (e.g., transceiver), and a memory 110. The network 104 further comprises, for example, a serving cell 112, a non-serving cell 114, a first network 116 and a second network 118. In FIG. 1, the processor 106, the communication circuit 108, and memory 110 are connected each other to perform operations.

In an embodiment herein, the first network 116 and the second network 118 are same networks. In an embodiment herein, the first network 116 and the second network 118 are different networks.

In an embodiment herein, the processor 106 comprises an MBS module 120, an interest determination module 122, and a report module 124. The MBS module 120 can receive unicast from at least one serving cell 112 on the first network 116. The MBS module 120 can further receive at least one MBS service from at least one non-serving cell 114 on the second network 118. The MBS service can comprise at least one of an MBS multicast service and an MBS broadcast service. The MBS service can further comprise one or more MBS session(s). In an embodiment herein, the MBS module 120 can derive an Implementation factor (I-factor), based on a UE hardware configuration or implementation aspects that can decide how much scaling or moderation is needed for the UE's processing capability. The derived I-factor can be utilized to scale or moderate a UE's processing capability for the MBS service reception on the non-serving cell 114 and a UE's actual processing capability for the unicast reception on the serving cell 112.

The I-factor can be based on at least one of the hardware components that are shared across unicast and broadcast reception paths, utilization for multiple-input multiple-output (MIMO) or multiple frequencies based configurations, implementation aspects in terms of processing power, radio frequency (RF) capability, discrete Fourier transform (DFT)/fast Fourier transform (FFT) sizes, memory, and so on. The I-factor can help the UE 102 to properly scale or moderate the UE's processing capability for the broadcast reception and/or UE's actual processing capability for unicast reception. The I-factor can be communicated to the network 104 in an uplink signaling, which may include at least one of UE capability information message, UE assistance information message, RRC setup complete message or MBS interest indication message. For example, if the I-factor is static quantity or parameter, it may be reported in at least one of the UE capability information message or RRC setup complete message. If the I-factor is a dynamic quantity or parameter, the I-factor may be reported in at least one of the UE assistance information message or MBS interest indication message. In an embodiment herein, the MBS module 120 can locally adapt/adjust the UE's actual processing capability based on the derived I-factor and obtain an updated UE's actual processing capability. The UE 102 further reports the updated UE's actual processing capability to the network 104; i.e., the UE does not explicitly report the I-factor to the network.

In an embodiment herein, the UE 102 reports the I-factor to the network 104. The network 104 then adapts/adjusts the UE's actual processing capability which may be dynamically received from the UE 102 with the reported I-factor. Accordingly, the network 104 calculates the updated UE actual processing capability in order to assess the performance achievable and suitable configuration to be applied to the UE 102.

In an embodiment herein, the interest determination module 122 can determine whether the UE 102 is interested in the MBS service from the non-serving cell 114. The interest determination module 122 can determine whether the UE 102 is receiving unicast from the serving cell 112 and the UE 102 is receiving or interested to receive the MBS service from the non-serving cell 114.

In an embodiment herein, the report module 124 can decide whether to report the MBS service reception from the non-serving cell 114 to the serving cell 112 in an MBS Interest Indication (MII) message, based on the determination received from the interest determination module 122. The report module 124 can report the MBS service reception from the non-serving cell 114 to the serving cell 112 in the MII message, after the UE 102 starts receiving the MBS service from the non-serving cell 114, if the UE 102 is interested in the MBS service from the non-serving cell 114. In an embodiment herein, the report module 124 can report proactively the MBS service reception from the non-serving cell 114 to the serving cell 112 in the MII message with partial information, before the UE 102 starts receiving the MBS service from the non-serving cell 114, if the UE 102 is interested in the MBS service from the non-serving cell 114. For example, the UE 102 is interested in the MBS broadcast service on the non-serving cell 114, but the service has yet not started. In an embodiment herein, the report module 124 can skip reporting the MBS service reception from the non-serving cell 114 to the serving cell 112 in the MII message, if the unicast is presently not being received from the serving cell 112 and the UE 102 is receiving or interested to receive the MBS service from the non-serving cell 114. In an embodiment herein, the report module 124 can report the MII message for the MBS service reception from the non-serving cell 114 based on at least one trigger.

In an embodiment herein, the triggers for sending MBS Interest Indication message to report for the MBS reception on the non-serving cell 114 may include, but not limited to, start receiving one or more broadcast service/session or stop receiving one or more broadcast service/session or complete stop of all broadcast services/sessions or certain parameters of broadcast service/session reception may change, for example, at least one of bandwidth, bandwidth part (BWP), sub-carrier spacing (SCS), frequency, common frequency resource (CFR), a number of physical resource blocks (PRBs), a number of reception paths/links/circuits (Rx), a number of transmission path/links/circuits (Tx), multiple input multiple output (MIMO) layers used) or cell selection/reselection/handover to MBS cell/non-MBS cell enables/disables MBS reception or RRC state change, DRX configuration change for broadcast service on non-serving cell(s), scheduling change for broadcast service on non-serving cell(s), RRC state change on the non-serving cell, the resultant baseband resource and/or processing requirement to receive broadcast services for the UE is changed.

In an embodiment herein, the UE 102, which is in RRC_CONNECTED state on the serving cell 112, may initiate the MBS interest indication procedure on the serving cell 112 corresponding to the MBS broadcast reception on the non-serving cell(s) 114 in at least one trigger. The trigger comprises at least one of one or more events as given below:
upon start of at least one MBS reception from the non-serving cell 114. The MBS reception comprises at least one of a MBS broadcast reception and a MBS multicast reception,
upon stop of the MBS reception from the non-serving cell 114,
upon loss of interest in the MBS reception from the non-serving cell 114,
upon gain of interest in the MBS reception from the non-serving cell 114,
upon start of at least one MBS session (or service) from the non-serving cell 114. The MBS session comprises at least one of a MBS broadcast session and a MBS multicast session,
upon stop of the MBS session (or service) from the non-serving cell 114,
upon loss of interest in the MBS session (or service) from the non-serving cell 114,
upon gain of interest in the MBS session (or service) from the non-serving cell 114,
upon change of bandwidth of the MBS reception from the non-serving cell 114,
upon change of at least one of sub-carrier spacing (SCS), common frequency resource (CFR), CFR bandwidth, frequency and number of physical resource blocks of the MBS reception from the non-serving cell 114,
upon change to a Primary Cell (PCell) providing a nonServingCellMII parameter in a System Information Block 1 (SIB1), and/or
upon change of a set of MBS broadcast frequencies of interest from a list of MBS broadcast frequencies of interest in the last transmission of the MII message for the MBS broadcast reception from the non-serving cell 114. In an embodiment herein, the MII message include reporting corresponding to the MBS broadcast reception on the non-serving cell(s). The MII message comprises a plurality of parameters of the MBS service reception. The parameters can be, but not limited to, at least one of bandwidth, bandwidth part (BWP), sub-carrier spacing (SCS), frequency, common frequency resource (CFR), a number of physical resource blocks (PRBs), a number of reception paths (Rx), a number of transmission paths (Tx), a number of MIMO layers used or cell selection/reselection/handover to the serving cell 112/the non-serving cell 114 that enables/disables MBS reception or RRC state change, band or band combination, DFT/FFT size, throughput, carriers, carrier aggregation, dual connectivity, services information or number of services, discontinuous reception (DRX) configuration change for broadcast service on the non-serving cell(s) 114, scheduling information (scheduling change for broadcast service on the non-serving cell(s) 114), RRC state change on the non-serving cell 114, and the resultant baseband resource and/or processing requirement to receive broadcast services for the UE 102 is changed, and so on. In an embodiment herein, the MII message can comprise at least one time-domain parameter to cater to at least one of the DRX configuration, and a scheduling pattern of the MBS service being accessed on the non-serving cell 114. Further, the MBS Interest Indication message is sent to the serving cell 112.

In an embodiment herein, the report module 124 can send the MII message to the serving cell 112 when a status of the MBS service reception and/or interest of the MBS service on the non-serving cell 114 changes from a previously reported MII message.

In an embodiment herein, the report module 124 can send an empty mbs-NonServingInfo-r18 information element (IE) in the MII message to the serving cell 112. The empty mbs-NonServingInfo-r18 IE indicates that the status of the MBS service reception on the non-serving cell 114 is changed and the UE 102 is no longer receiving and/or is no longer interested to receive the MBS service from the non-serving cell 114, since the last transmission of the MII message that indicated the UE 102 is receiving or interested to receive the MBS service. In an embodiment herein, the report module 124 can send an empty MBSInterestIndication-v18xy IE in the MII message to the serving cell 112. The empty MBSInterestIndication-v18xy IE indicates that the status of the MBS service reception on the non-serving cell 114 is changed and the UE 102 is no longer receiving and/or is no longer interested to receive the MBS service from the non-serving cell 114, since the last transmission of the MII message that indicated the UE 102 is receiving or interested to receive the MBS service.

In an embodiment herein, the report module 124 can report the I-factor to the network 104 in an uplink signaling, where the I-factor is received from the MBS module 120. The uplink signaling can comprise at least one of a UE capability information message, a UE assistance information message, an RRC setup complete message, and the MII message. For example, if the I-factor is static quantity or parameter, the I-factor can be reported in at least one of the UE capability information message or RRC setup complete message. If the I-factor is a dynamic quantity or parameter, the I-factor can be reported in at least one of the UE assistance information message or MII message. The report module 124 can report the updated UE's actual processing capability to the network 104 (i.e., the UE 102 does not explicitly report the I-factor to the network 104), where the updated UE's actual processing capability is received from the MBS module 120.

In an embodiment herein, the report module 124 reports the I-factor to the network 104. The network 104 can receive the derived I-factor and the UE's actual processing capability from the UE 102. The network 104 can adjust the UE's actual processing capability which may be dynamically received from the UE 102 with the reported I-factor, based on the derived I-factor. Accordingly, the network 104 calculates the updated UE actual processing capability in order to assess the performance achievable and suitable configuration to be applied to the UE 102.

In an embodiment herein, the time-domain parameter is represented by a utilization factor (U-factor). The U-factor can be at least one of a number, a fraction, a percentage, a percentile, and a ratio. The U-factor may be a ratio of time for broadcast access (or DRX configuration or scheduled pattern period) over the non-serving cell 114 to the overall time. For instance, if the UE 102 is accessing broadcast services 40% of the time, then the U-factor may be 0.4, and then the U-factor can be used to clearly access how much processing capability is used up on the second network 118, already given the frequency domain parameters. The U-factor aids in enhanced scaling of the processing capability used for broadcast reception. Therefore, the UE actual capability available for unicast reception on the first network 116 can be accurately estimated. This enables optimum configuration and higher data throughput performance for the UE 102 and the network 104. This may result in poorer configuration for the unicast and lower throughput may be achieved.

In an embodiment herein, the MII message is triggered and reported when the U-factor is altered by a threshold quantity. The threshold quantity can comprise at least one of a configured parameter by a network 104 in a SIB or a radio resource control (RRC) signaling message, or the threshold quantity can be determined by a UE implementation itself, or is a parameter which is specified in standards.

In an embodiment herein, an example of specification is provided as below to incorporate at least one time-domain information in the MBS interest indication message as shown in TABLE 1.

TABLE 1
Setting of contents of MBS interest indication.

```
5.X.Y.Z Setting of contents of MBS Interest Indication:
The UE (100) may set the contents of the MBS Interest Indication as follows:
  1>if the set of MBS frequencies of interest, determined in accordance with 3GPP
  standard specification is not empty:
    2>include mbs-FreqList and set it to include the MBS frequencies of interest
    sorted by decreasing order of interest, using the absoluteFrequencySSB for
    serving frequency, if applicable, and the ARFCN-ValueNR(s) as included in
    SIB21 or in USD (for neighbouring frequencies);
    2>include mbs-Priority if the UE priorities reception of all indicated MBS
    frequencies above reception of any of the unicast bearers and multicast MRBs;
Please note that if the UE 102 prioritizes MBS broadcast reception and unicast/multicast data
cannot be supported because of congestion on the MBS carrier(s), NG-RAN may for example
initiate release of unicast bearers/multicast MRBs.
    2>if SIB20 is provided for the PCell or for the SCell:
      3>include mbs-ServiceList and set it to indicate the set of MBS services
      of interest sorted by decreasing order of interest determined in accordance
      with 3GPP standard specification.
  1>if the UE is receiving MBS service(s) (e.g., an MBS broadcast service on a secondary
  cell or on a non-serving cell or on another network) and UE is indicated with
  sharedProcessingInfoReporting (i.e., MII reporting for simultaneous reception of
  broadcast and unicast) in SIB1:
    2>if the supportedBandCombination the UE included in UE-Capability contains
    at least one band combination including the MBS frequency:
      3>include one or more frequency domain parameters for shared
      Processing Information Report (e.g., Frequency, SubcarrierSpacing and
      Bandwidth) in the MBS Interest Indication message;
    2>include one or more time domain parameters for shared Processing
    Information Report (e.g., utilization factor) in the MBS Interest Indication
    message.
```

In an embodiment herein, the MII message includes reporting for the MBS reception on the serving cell 112 and/or reporting for the MBS reception (for example, MBS broadcast) on the non-serving cell(s) 114.

In an embodiment herein, upon change to the PCell providing nonServingCellMII in the SIB1, the UE 102 may initiate the MII procedure on the PCell corresponding to the MBS broadcast reception on the non-serving cell(s) 114.

In an embodiment herein, a MBS capable UE in RRC_CONNECTED may initiate the procedure in several cases including upon successful connection establishment/resume, upon entering or leaving the broadcast service area, upon MBS broadcast session start or stop, upon change of interest, upon change of priority between MBS broadcast reception and unicast/multicast reception, upon change to a PCell providing SIB21 (i.e., where the SIB1 scheduling information contains SIB21), upon receiving SIB20 of an SCell via dedicated signalling, upon handover, and upon RRC connection re-establishment, upon change to a PCell providing nonServingCellMII in SIB1, upon start or stop receiving at least one MBS broadcast service on a non-serving cell 114, and upon change of bandwidth, common frequency resource (CFR), number of physical resource blocks (PRBs) or subcarrier spacing of MBS broadcast reception on a non-serving cell 114.

In an embodiment herein, upon change to a PCell providing nonServingCellMII in SIB1 but not providing SIB21, the UE 102 may initiate the MII procedure on the PCell corresponding to the MBS broadcast reception on the non-serving cell(s) 114.

In an embodiment herein, the UE 102 considers the frequency of as an MBS frequencies of interest in which the UE 102 is receiving or interested to receive at least one MBS session (or service) via broadcast MRB. The MBS session (or service) is ongoing or about to start and at least one of the MBS sessions (or service) is from the non-serving cell 114, and the supportedBandCombinationList the UE 102 included in UE-NR-Capability contains at least one band combination including the concerned MBS frequency. This MBS frequency of interest is reported to the serving cell 112 network as part of the MII message. In an embodiment herein, a frequency of the non-serving cell 114 is included in the MII message on the serving cell 112, if the serving cell 112 broadcasts the nonServingCellMII parameter as part of the SIB1 message. The UE 102 considers the frequency to be part of the list of MBS broadcast frequencies of interest for the MBS session from the non-serving cell 114, wherein SIB21 acquired from the non-serving cell 114 includes mapping of the concerned frequency and one or more MBS FSAIs (Frequency Service Selection Area Identity) indicated in USD for the MBS session or concerned frequency is not included in the SIB21 from the non-serving cell 114 but is indicated in the USD for the MBS session.

In an embodiment herein, the processor 106 can process and execute data of a plurality of modules of the UE 102. The processor 106 can be configured to execute instructions stored in the memory 110. The processor 106 may comprise one or more of microprocessors, circuits, and other hardware configured for processing. The processor 106 can be at least one of a single processer, a plurality of processors, multiple homogeneous or heterogeneous cores, multiple central processing units (CPUs) of different kinds, microcontrollers, special media, and other accelerators. The processor 106 may be an application processor (AP), a graphics-only processing unit (such as a graphics processing unit (GPU), a visual processing unit (VPU)), and/or an artificial intelligence (AI)-dedicated processor (such as a neural processing unit (NPU)).

In an embodiment herein, the plurality of modules of the processor 106 of the UE 102 can communicate with the via the communication circuit 108. The communication circuit 108 may be in the form of either a wired network or a wireless communication network module. The wireless communication network may comprise, but not limited to, global positioning system (GPS), global system for mobile communications (GSM), Wi-Fi, Bluetooth low energy, near-field communication (NFC), and so on. The wireless communication may further comprise one or more of Bluetooth, ZigBee, a short-range wireless communication (such as ultra-wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory 110 may comprise one or more volatile and non-volatile memory components which are capable of storing data and instructions of the modules of the UE 102 to be executed. Examples of the memory 110 can be, but not limited to, NAND, embedded multi media card (eMMC), secure digital (SD) cards, universal serial bus (USB), serial advanced technology attachment (SATA), solid-state drive (SSD), and so on. The memory 110 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted to mean that the memory 110 is non-movable. In certain examples, a non-transitory storage medium may store data that can, over time, change (for example, in Random Access Memory (RAM) or cache).

FIG. 1 shows example modules of the UE 102, but it is to be understood that other embodiments are not limited thereon. In other embodiments, the UE 102 may include less or more number of modules. Further, the labels or names of the modules are used only for illustrative purpose and does not limit the scope of the invention. One or more modules can be combined together to perform same or substantially similar function in the UE 102.

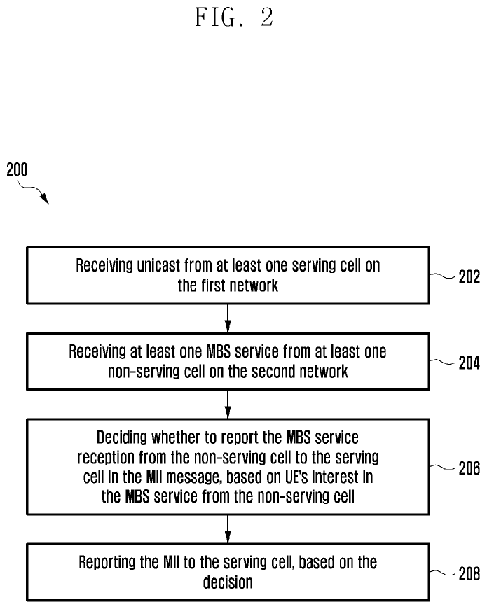

FIG. 2 illustrates a method 200 for simultaneous MBS and unicast reception. The method 200 comprises receiving, by the UE 102, unicast from at least one serving cell 112 on the first network 116, as depicted in step 202. The method 200 comprises receiving, by the UE 102, at least one MBS service from at least one non-serving cell 114 on the second network 118, as depicted in step 204. Thereafter, the method 200 comprises deciding, by the UE 102, whether to report the MBS service reception from the non-serving cell 114 to the serving cell 112 in the MII message, as depicted in step 206. The UE 102 decides reporting of the MBS service reception, based on UE's interest in the MBS service from the non-serving cell 114. The method 200 further comprises reporting, by the UE 102, the MII to the serving cell 112, based on the decision, as depicted in step 208.

The various actions in method 200 may be performed in the order presented, in a different order or simultaneously. Further, in some embodiments, some actions listed in FIG. 2 may be omitted.

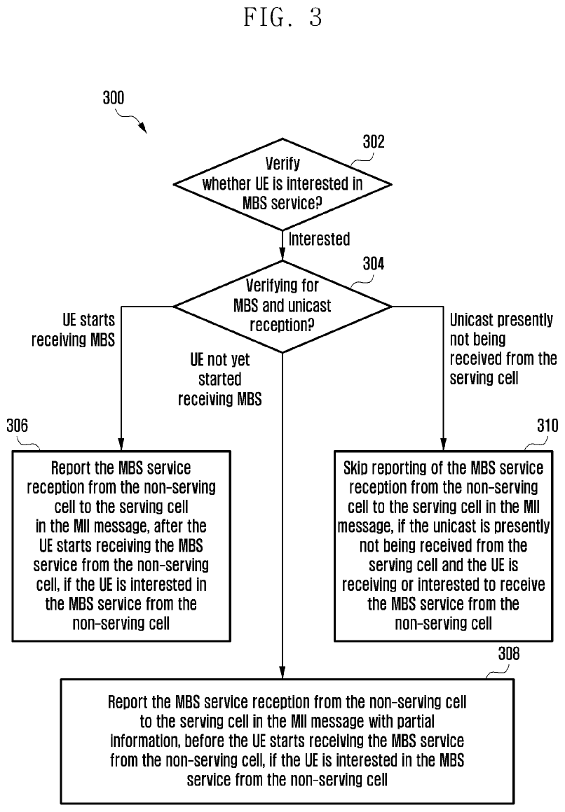

FIG. 3 illustrates a method 300 for reporting the MBS service reception to the serving cell 112 in the MII message. The method 300 comprises verifying, by the UE 102, whether the UE 102 is interested in the MBS service, as depicted in step 302. The method 300 comprises verifying, by the UE 102, for MBS and unicast reception, if the UE 102 is interested in the MBS service, as depicted in step 304. The method 300 comprises reporting, by the UE 102, the MBS service reception from the non-serving cell 114 to the serving cell 112 in the MII message, after the UE 102 starts receiving the MBS service from the non-serving cell 114, if the UE 102 is interested in the MBS service from the non-serving cell 114, as depicted in step 306.

The method 300 comprises reporting, by the UE 102, the at least one MBS service reception from the non-serving cell 114 to the serving cell 112 in the MII message with partial information (for example, there can be partial information in the MII including at least one of frequency, sub-carrier spacing or common frequency response before the UE actually receives the MBS service on the non-serving cell), before the UE 102 starts receiving the MBS service from the non-serving cell 114, if the UE 102 is interested in the MBS service from the non-serving cell 114, as depicted in step 308. The method 300 comprises skipping, by the UE 102, reporting of the MBS service reception from the non-serving cell 114 to the serving cell 112 in the MII message, if the unicast is presently not being received from the serving cell 112 and the UE 102 is receiving or interested to receive the MBS service from the non-serving cell 114, as depicted in step 310.

The various actions in method 300 may be performed in the order presented, in a different order or simultaneously. Further, in some embodiments, some actions listed in FIG. 3 may be omitted.

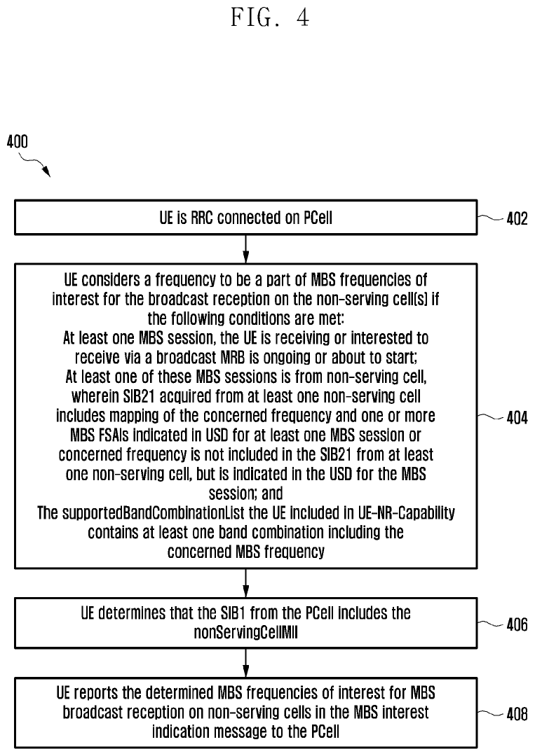

FIG. 4 illustrates a method 400 for determining the frequency of interest for MII reporting for the MBS broadcast service reception on the non-serving cell 114. The UE 102 is RRC connected on the PCell, as depicted in step 402. The UE 102 considers a frequency to be a part of MBS frequencies of interest for the broadcast reception on the non-serving cell(s) 114, as depicted in step 404, if the following conditions are met:
when at least one MBS session (or service), the UE is receiving or interested to receive via a broadcast MRB is ongoing or about to start;
when at least one of these MBS sessions (or service) is from the non-serving cell, wherein SIB21 acquired from at least one non-serving cell includes mapping of the concerned frequency and one or more MBS FSAIs (Frequency Service Selection Area Identity) indicated in USD (User Service Description) for at least one MBS session or concerned frequency is not included in the SIB21 from the non-serving cell, but is indicated in the USD for the MBS session; and/or
when the supportedBandCombinationList the UE included in UE-NR-Capability contains at least one band combination including the concerned MBS frequency.

The UE 102 determines that the SIB1 from the PCell includes the nonServingCellMII, as depicted in step 406. The UE 102 reports the determined MBS frequencies of interest for MBS broadcast reception on non-serving cells 114 in the MII message to the PCell, as depicted in step 408.

The various actions in method 400 may be performed in the order presented, in a different order or simultaneously. Further, in some embodiments, some actions listed in FIG. 4 may be omitted.

In an embodiment herein, following examples are provided for MBS interest indication for the MBS broadcast reception on the non-serving cell 114.

TABLE 2
MBS frequencies of interest determination

```
5.9.4.3 MBS frequencies of interest determination
The UE may:
  1>consider a frequency to be part of the MBS frequencies of interest if the following
  conditions are met:
    2>at least one MBS session the UE is receiving or interested to receive via a broadcast
    MRB is ongoing or about to start; and
NOTE 1: The UE may determine whether the session is ongoing from the start and stop time
indicated in the User Service Description (USD), see TS 38.300 or TS 23.247.
    2>for at least one of these MBS sessions, SIB21 acquired from the PCell includes
    mapping between the concerned frequency and one or more MBS FSAIs indicated in
    the USD for this session, or for at least one of these MBS sessions, the concerned
    frequency is not included in SIB21 but is indicated in the USD for this session or this
    session is from non-serving cell; and
NOTE 2: The UE considers a frequency to be part of the MBS frequencies of interest even
though NG-RAN may (temporarily) not employ a broadcast MRB for the concerned session,
i.e., the UE does not verify if the session is indicated on MCCH.
    2>the supportedBandCombinationList the UE included in UE-NR-Capability contains
    at least one band combination including the concerned MBS frequency.
NOTE 3: When evaluating which frequencies, the UE is capable of receiving, the UE does not
take into account whether they are currently configured as serving frequencies.
```

```
TABLE 3
5.9.4.3 MBS frequencies of interest determination
The UE may:
  1>consider a frequency to be part of the MBS frequencies of interest if the following
  conditions are met:
    2> at least one MBS session the UE is receiving or interested to receive via a
    broadcast MRB is ongoing or about to start; and
NOTE 1: The UE may determine whether the session is ongoing from the start and stop time
indicated in the User Service Description (USD), see TS 38.300 or TS 23.247.
    2>for at least one of these MBS sessions, SIB21 acquired from the PCell includes
    mapping between the concerned frequency and one or more MBS FSAIs indicated
    in the USD for this session, or for at least one of these MBS sessions, the concerned
    frequency is not included in SIB21 but is indicated in the USD for this session or at
    least one of these MBS sessions is from non-serving cell; and
NOTE 2: The UE considers a frequency to be part of the MBS frequencies of interest even
though NG-RAN may (temporarily) not employ a broadcast MRB for the concerned session,
i.e., the UE does not verify if the session is indicated on MCCH.
    2>the supportedBandCombinationList the UE included in UE-NR-Capability
    contains at least one band combination including the concerned MBS frequency.
NOTE 3: When evaluating which frequencies, the UE is capable of receiving, the UE does not
take into account whether they are currently configured as serving frequencies.
```

TABLE 4
MBS frequencies of interest determination

```
5.9.4.3 MBS frequencies of interest determination
The UE may:
  1>consider a frequency to be part of the MBS frequencies of interest if the following
  conditions are met:
    2>at least one MBS session the UE is receiving or interested to receive via a
    broadcast MRB is ongoing or about to start; and
NOTE 1: The UE may determine whether the session is ongoing from the start and stop time
indicated in the User Service Description (USD), see TS 38.300 or TS 23.247.
    2>for at least one of these MBS sessions, SIB21 acquired from the PCell
    includes mapping between the concerned frequency and one or more MBS
    FSAIs indicated in the USD for this session, or for at least one of these MBS
    sessions, the concerned frequency is not included in SIB21 but is indicated in
    the USD for this session or at least one of these MBS sessions is from non-
    serving cell and SIB1 acquired from the PCell includes nonServingCellMII; and
NOTE 2: The UE considers a frequency to be part of the MBS frequencies of interest even
though NG-RAN may (temporarily) not employ a broadcast MRB for the concerned session,
i.e., the UE does not verify if the session is indicated on MCCH.
    2>the supportedBandCombinationList the UE included in UE-NR-Capability
    contains at least one band combination including the concerned MBS frequency.
NOTE 3: When evaluating which frequencies, the UE is capable of receiving, the UE does not
take into account whether they are currently configured as serving frequencies.
```

In an embodiment herein, the mbs-FreqList is redefined as list of MBS frequencies on which the UE 102 is receiving or interested to receive MBS broadcast service via a broadcast MRB on the serving cell(s) 112. The UE 102 determines if the UE 102 did not transmit the MII message since last entering RRC_CONNECTED state or if since the last time the UE 102 transmitted an MII message, the UE 102 connected to a PCell neither providing SIB21 nor including nonServingCellMII in SIB1, then if the set of MBS broadcast frequencies of interest for MBS broadcast reception on the serving cell(s) 112, determined in accordance with 3GPP standard specification, is not empty; or if the set of MBS broadcast frequencies of interest for MBS broadcast reception on the non-serving cell(s) 114 is not empty. Alternatively, the UE 102 compares and determines if the set of MBS broadcast frequencies of interest for MBS broadcast reception on the serving cell(s) 112 is different from mbs-FreqList included in the last transmission of the MII message, or if the set of MBS broadcast frequencies of interest for MBS broadcast reception on the non-serving cell(s) 114 is different from the list of MBS broadcast frequencies of interest for MBS broadcast reception on the non-serving cell 114 included in the last transmission of the MII message. The UE 102 initiates the MII message transmission when either of the conditions is met. An example for specification is provided as shown in TABLE 5 and TABLE 6.

TABLE 5
UE procedures

Upon initiating the procedure, the UE 102 may:

| 1> | if SIB21 is provided by the PCell; or | |
|---|---|---|
| 1> | if nonServingCellMII is provided in SIB1 by the PCell; | |
| | 2> | ensure having a valid version of SIB21 for the PCell, if present; |
| | 2> | if the UE did not transmit MBS Interest Indication since last entering |
| | RRC_CONNECTED state; or | |
| | 2> | if since the last time the UE transmitted an MBS Interest Indication, the |

UE connected to a PCell neither providing SIB21 nor including
nonServingCellMII in SIB1:

| 3> | if the set of MBS broadcast frequencies of interest for MBS |
|---|---|
| broadcast reception on the serving cell(s), determined in accordance with | |
| 3GPP standard specification, is not empty; or | |
| 3> | if the set of MBS broadcast frequencies of interest for MBS |

broadcast reception on non-serving cell(s), determined in accordance
with 3GPP standard specification, is not empty:

| | |
|---|---|
| 4> | set the contents of MBS Interest Indication according to |

3GPP standard specification and initiate transmission of the
MBSInterestIndication message;

| | |
|---|---|
| 2> | else: |

| 3> | if the set of MBS broadcast frequencies of interest for MBS |
|---|---|
| broadcast reception on the serving cell(s), determined in accordance with | |
| 3GPP standard specification, is different from mbs-FreqList included in | |
| the last transmission of the MBS Interest Indication; or | |
| 3> if the set of MBS broadcast frequencies of interest for MBS broadcast | |
| reception on non-serving cell(s), determined in accordance with 3GPP | |
| standard specification, is different from the list of MBS broadcast | |
| frequencies of interest for MBS broadcast reception on non-serving cell | |
| included in the last transmission of the MBS Interest Indication; or | |
| 3> | if at least one of the subcarrier spacing, CFR and the bandwidth |

for MBS broadcast reception on the non-serving cell, has changed since
the last transmission of the MBS Interest Indication; or
3> if the prioritization of reception of all indicated MBS broadcast
frequencies compared to reception of any of the established unicast
bearers and multicast MRBs has changed since the last transmission of
the MBS Interest Indication:

| | |
|---|---|
| 4> | set the contents of MBS Interest Indication according to |

3GPP standard specification and initiate transmission of the
MBSInterestIndication message;

NOTE: The UE 102 may send MII even when it is able to receive the MBS services it
is interested in, i.e., to avoid that the network 104 allocates a configuration inhibiting
MBS broadcast reception.

| | |
|---|---|
| 3> | else if SIB20 is provided for the PCell or for the SCell: |

| 4> | if since the last time the UE transmitted the MBS Interest |
|---|---|
| Indication, the UE connected to a PCell not providing SIB20 and | |
| the UE was not provided with SIB20 for an SCell; or | |
| 4> | if the set of MBS broadcast services of interest determined |

in accordance with 3GPP standard specification is different from
mbs-ServiceList included in the last transmission of the MBS
Interest Indication:

5> set the contents of MBS Interest Indication
according to 3GPP standard specification and initiate the
transmission of MBSInterestIndication message.

TABLE 6
MBS interest indication

MBSInterestIndication-r17-IEs ::= SEQUENCE {

| | |
|---|---|
| mbs-FreqList-r17 CarrierFreqListMBS-r17 | OPTIONAL, |
| mbs-Priority-r17 ENUMERATED {true} | OPTIONAL, |
| mbs-ServiceList-r17 MBS-ServiceList-r17 | OPTIONAL, |
| lateNonCriticalExtension OCTET STRING | OPTIONAL, |

| | |
|---|---|
| nonCriticalExtension MBSInterestIndication-v18xy | OPTIONAL |

```
}
MBSInterestIndication field descriptions:
    Note:
    1. mbs-FreqList is the list of MBS frequencies on which the UE is receiving or
    interested to receive MBS broadcast service via a broadcast MRB on serving cell(s).
    2. mbs-Priority indicates whether the UE prioritizes MBS broadcast reception above
    unicast and MBS multicast reception. The field is present (i.e., value true), if the UE
    prioritizes reception of broadcast services, on frequencies indicated in mbs-FreqList,
    above a reception of any of the unicast bearers and multicast MRBs. Otherwise, the
    field is absent.
    3. mbs-ServiceList is the list of MBS broadcast services which the UE is receiving or
    interested to receive.
```

In an embodiment herein, the UE 102 sends an MII message to the serving cell 112 when the status of broadcast reception and/or broadcast interest on a non-serving cell 114 changes from the previously reported MII message.

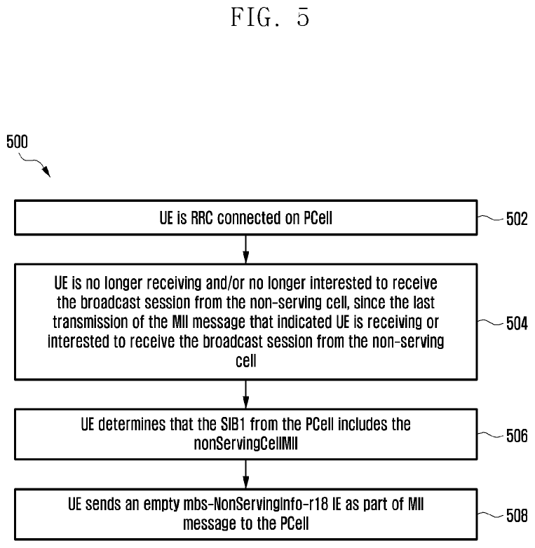

FIG. 5 illustrates a method 500 for MII reporting for the MBS broadcast service reception on the non-serving cell 114, when the UE 102 is no longer receiving or no longer interested in MBS broadcast service on the non-serving cell 114, since the last transmission of the MII message. The UE 102 is RRC connected on the PCell, as depicted in step 502. The UE 102 is no longer receiving and/or no longer interested to receive the broadcast session from the non-serving cell 114, depicted in step 504, since the last transmission of the MII message that indicated the UE 102 is receiving or interested to receive the broadcast session from the non-serving cell 114. The UE 102 determines that the SIB1 from the PCell includes the nonServingCellMII, depicted in step 506. Thereafter, the UE 102 sends an empty mbs-NonServingInfo-r18 IE as part of the MII message to the PCell, depicted in step 508.

Therefore, the UE 102 sends an empty mbs-NonServingInfo-r18 IE as part of MII message to the serving cell 112 to indicate that the broadcast reception status on the non-serving cell 114 is changed and the UE 102 is no longer receiving and/or no longer is interested to receive the broadcast session from the non-serving cell 114, since the last transmission of the MII message that indicated the UE 102 is receiving or interested to receive the broadcast session from the non-serving cell 114.

The various actions in method 500 may be performed in the order presented, in a different order or simultaneously. Further, in some embodiments, some actions listed in FIG. 5 may be omitted.

In an embodiment herein, the UE 102 does not include the mbs-NonServingInfo-r18 IE in the MII message to the serving cell 112 if the UE 102 is currently not receiving and/or is not interested to receive a broadcast session from the non-serving cell 114 and has not indicated in the last reported MII message that it is receiving or is interested to receive a broadcast session from the non-serving cell 114.

In an embodiment herein, the UE 102 sends an indication as a field or a flag or a bit or a bitmap included in the MII message to the serving cell 112 to indicate that the broadcast reception status on the non-serving cell 114 is changed and the UE 102 is no longer receiving and/or no longer is interested to receive the broadcast session from the non-serving cell 114, since the last transmission of the MII message that indicated the UE 102 is receiving or interested to receive the broadcast session from the non-serving cell 114.

In an embodiment herein, the UE 102 sends an empty MBSInterestIndication-v18xy IE in the MII message to the serving cell 112 to indicate that the broadcast reception status on the non-serving cell 114 is changed, and the UE 102 is no longer receiving and/or no longer is interested to receive the broadcast session from the non-serving cell 114, since the last transmission of the MII message that indicated that the UE 102 is receiving or interested to receive the broadcast session from the non-serving cell 114. In an embodiment herein, for the discussed scenario, MBSInterestIndication-v18xy IE is not included in the MII message by the UE 102.

In an embodiment herein, the UE 102 sends an empty MII message to the serving cell 112 to indicate that the broadcast reception status on the non-serving cell 114 and/or the serving cell 112 is changed, and the UE 102 is no longer receiving and/or no longer is interested to receive the broadcast session from the non-serving cell 114 and/or the serving cell 112, since the last transmission of the MII message that indicated that the UE 102 is receiving or interested to receive the broadcast session from the non-serving cell 114 and/or the serving cell 112. For example, the MBSInterestIndication-v18xy IE is indicated as given below in TABLE 7.

TABLE 7
MBS interest indication

```
MBSInterestIndication-v18xy ::= SEQUENCE {
  mbs-NonServingInfo-r18 CarrierFreqListMBS-r18 OPTIONAL,
  lateNonCriticalExtension OCTET STRING OPTIONAL,
  nonCriticalExtension SEQUENCE{ } OPTIONAL
}
-- TAG-MBSINTERESTINDICATION-STOP
-- ASN1STOP
```

The IE mbs-NonServingInfo indicates the information for MBS broadcast reception on the non-serving cell 114. The UE 102 signals an empty list (i.e., an empty container for mbs-NonServingInfo) to indicate that UE 102 is no longer receiving or no longer interested to receive broadcast service on the previously reported frequencies on the non-serving cell 114.

In an embodiment herein, MBS services of interest determination are carried out by the UE by considering only for the MBS service(s) that the UE is receiving or interested to receive via a broadcast MRB on serving cell(s). That is, the MBS service(s) that the UE is receiving or interested to receive via a broadcast MRB on non-serving cell(s) are not considered for this determination. Further, UE considers another condition as one or more MBS FSAIs in the USD for this service is included in SIB21 acquired from the PCell for a frequency belonging to the set of MBS frequencies of interest for MBS broadcast reception on serving cell(s). That is, the set of MBS frequencies of interest for MBS broadcast reception on non-serving cell(s) is not considered. An example for specification is provided as below in TABLE 8.

TABLE 8
MBS services of interest determination

```
5.9.4.4 MBS services of interest determination
The UE may:
  1>consider an MBS service to be part of the MBS services of interest if the following
  conditions are met:
      2>the UE is receiving or interested to receive this service via a broadcast MRB on
    serving cell(s); and
      2>the session of this service is ongoing or about to start; and
    2>one or more MBS FSAIs in the USD for this service is included in SIB21 acquired
    from the PCell for a frequency belonging to the set of MBS frequencies of interest for
    MBS broadcast reception on serving cell(s), determined according to 3GPP standard
    specification SIB21 acquired from the PCell does not provide the frequency mapping
    for the concerned service but that frequency is included in the USD of this service.
NOTE: The UE may determine whether the session is ongoing from the start and stop time
indicated in the User Service Description (USD), see TS 38.300 or TS 23.247.
```

In an embodiment herein, at least one time-domain parameter or information is provided in the MII message by the UE 102 to the first network 116. This time-domain parameter is in addition to the frequency domain parameters of the frequency, bandwidth, CFR and sub-carrier spacing parameters for the broadcast services being received on the second network 118. The time-domain parameter caters to at least one of the DRX configuration and scheduling pattern of the broadcast service(s) being accessed on the second network 118. Together with the frequency-domain and time-domain parameters, the first network 116 can better assess the processing capability of the UE 102 getting consumed by the broadcast service(s) access on the second network 118.

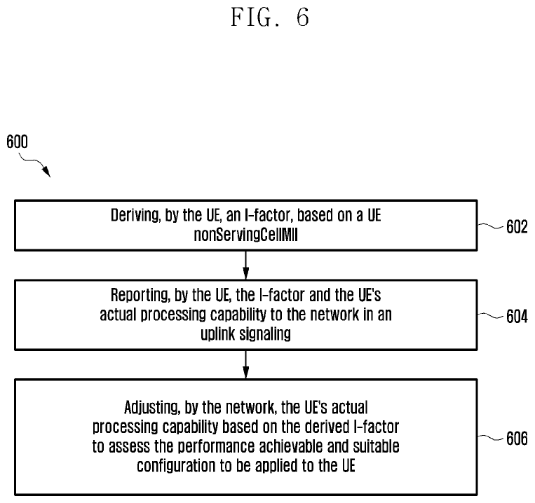

FIG. 6 illustrates a method 600 for scaling a UE's processing capability for the MBS service reception on the non-serving cell 114 and a UE's actual processing capability for the unicast reception on the serving cell 112. The method 600 comprises deriving, by the UE 102, the I-factor, based on a UE hardware configuration, as depicted in step 602. The method 600 comprises reporting, by the UE 102, the I-factor and the UE's actual processing capability to the network 104 in an uplink signaling, as depicted in step 604. The uplink signaling can comprise at least one of a UE capability information message, a UE assistance information message, an RRC setup complete message, and the MII message. Thereafter, the method 600 comprises adjusting, by the network 104, the UE's actual processing capability based on the derived I-factor to assess the performance achievable and suitable configuration to be applied to the UE 102, as depicted in step 606.

The various actions in method 600 may be performed in the order presented, in a different order or simultaneously. Further, in some embodiments, some actions listed in FIG. 6 may be omitted.

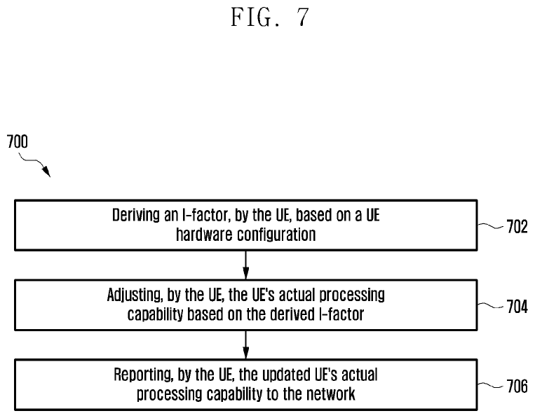

FIG. 7 illustrates an alternate method 700 for scaling a UE's processing capability for the MBS service reception on the non-serving cell 114 and a UE's actual processing capability for the unicast reception on the serving cell 112. The method 700 comprises deriving, by the UE 102, the I-factor, based on a UE hardware configuration, as depicted in step 702. The method 700 comprises adjusting, by the UE 102, the UE's actual processing capability based on the derived I-factor, as depicted in step 704. Thereafter, the method 700 comprises reporting, by the UE 102, the updated UE's actual processing capability to the network 104, as depicted in step 706.

The various actions in method 700 may be performed in the order presented, in a different order or simultaneously. Further, in some embodiments, some actions listed in FIG. 7 may be omitted.

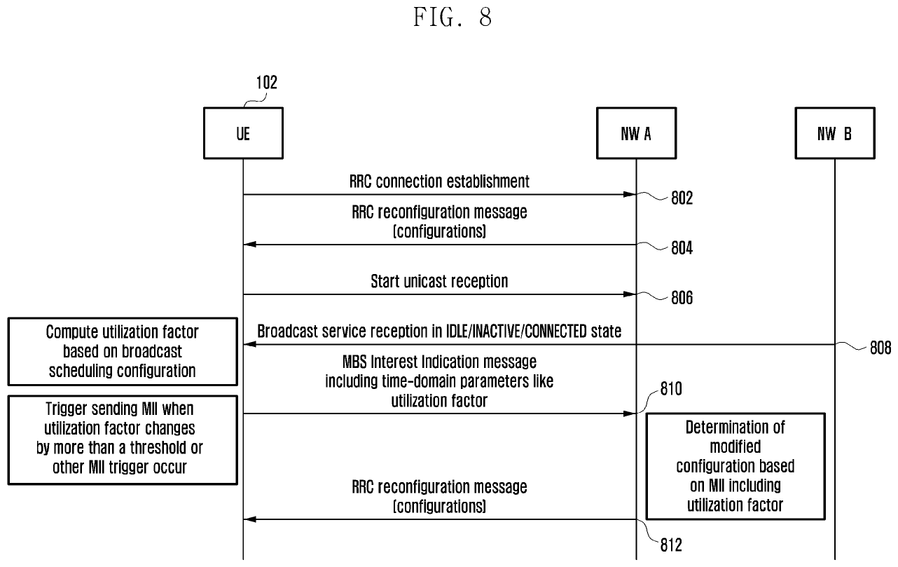

FIG. 8 illustrates a procedural flow for the simultaneous unicast and MBS broadcast reception. As depicted in step 802, a RRC connection establishment procedure is initiated between the UE 102 and network A (NW A). A RRC reconfiguration message (configurations) is communicated to the UE 102 from NW A, as depicted in step 804. Later, a unicast reception is started by the UE 102, as depicted in step 806. Further, the UE 102 receives a broadcast service from network B (NW B), as depicted in step 808, in RRC idle/inactive/connected state.

Thereafter, U-factor is computed by the UE 102 based on broadcast scheduling configuration. The UE 102 sends a MII message to the NW A, as depicted in step 810, where the MII message includes time-domain parameters such as the U-factor. The MII message is triggered when the U-factor changes by more than a threshold or when other MII trigger occurs. NW A determines a modified configuration based on the MII including the U-factor. Further, NW A sends a RRC reconfiguration message with the modified configuration, as depicted in step 812.

In an embodiment herein, at least one parameter or information pertaining to broadcast service (that the UE 102 is receiving or interested in) is provided in the MII message by the UE 102 to the first network 116. This is in addition to the frequency domain parameters of the frequency, bandwidth, CFR and sub-carrier spacing parameters for the broadcast services being received on the second network 118. The parameter may cater to at least one of the following:
1) Number of broadcast services that the UE is receiving or interested in;
2) Service identity that broadcast services that the UE is receiving or interested in;
3) The number of broadcast MRBs pertaining to broadcast services that the UE is receiving or interested in;
4) Broadcast MRB IDs pertaining to broadcast services that the UE is receiving or interested in;
5) Scheduling pattern or scheduling rate of the broadcast services that the UE is receiving or interested in;
6) DRX configuration parameters of the broadcast services that the UE is receiving or interested in; and/or
7) Number of MIMO layers, number of carriers, modulation and coding scheme of the broadcast services that the UE is receiving or interested in.

Therefore, the provided system 100 specifies the approaches for shared processing for simultaneous MBS broadcast and unicast reception, including:
Triggers for sending MII message for broadcast service reception on the non-serving cell,
Contents and format for MII message for broadcast service reception on the non-serving cell,
Proactive and reactive sending of MII for broadcast service reception on the non-serving cell,
Frequency of interest determination considering concerned frequency for session(s) from the non-serving cell,
SIB1 parameter based control of MII reporting for broadcast service reception on the non-serving cell,
Enable sending of empty “MBSInterestIndication-v18xy” or empty “NonServingInfo-r18” message to indicate the UE is no longer receiving MBS broadcast session from the non-serving cell, and/or
Time domain based utilization factor or implementation based factors consideration for MII reporting towards future standards or UE implementation solutions.

In an embodiment herein, examples of the specification are provided for MBS Interest Indication for the MBS broadcast reception on the non-serving cell as shown in TABLE 9. TABLE 10, and TABLE 11.

TABLE 9
Setting of the contents of MBS Interest Indication

```
5.9.4.5 Setting of the contents of MBS Interest Indication
The UE may set the contents of the MBS Interest Indication as follows:
  1> if the UE has a valid version of SIB21 for the PCell; and
  1> if the set of MBS frequencies of interest for MBS broadcast reception on serving cells,
    determined in accordance with 3GPP standard specification, is not empty:
    2> include mbs-FreqList and set it to include the MBS frequencies of interest sorted by
      decreasing order of interest, using the absoluteFrequencySSB for serving frequency,
      if applicable, and the ARFCN-ValueNR(s) as included in SIB21 or in USD (for
      neighbouring frequencies);
    2> include mbs-Priority if the UE prioritises reception of all indicated MBS frequencies
      above reception of any of the unicast bearers and multicast MRBs;
  NOTE 1: If the UE prioritises MBS broadcast reception and unicast/multicast data cannot
        be supported because of congestion on the MBS carrier(s), NG-RAN may for
        example initiate release of unicast bearers/multicast MRBs.
    2> if SIB20 is provided for the PCell or for the SCell:
      3> include mbs-ServiceList and set it to indicate the set of MBS services of interest
        sorted by decreasing order of interest determined in accordance with 3GPP standard
        specification.
  NOTE 2: The mbs-ServiceList is not required to be used by the NG-RAN to determine the
        frequency on which to enable MBS broadcast reception for the UE.
  1> if nonServingCellMII is included in SIB1 for the PCell; and
  1> if the set of MBS frequencies for MBS broadcast reception on non-serving cells,
    determined in accordance with 3GPP standard specification, is not empty:
    2> include the carrierFreqMBS, carrierBandwidth and subcarrierSpacing for MBS
      broadcast reception on the non-serving cell;
  1> else, if the set of MBS frequencies for MBS broadcast reception on non-serving cells,
    determined in accordance with 3GPP standard specification, is different from the list of
    MBS broadcast frequencies of interest for MBS broadcast reception on non-serving cell
    included in the last transmission of the MBS Interest Indication:
    2> include an empty container for NonServingInfo
```

TABLE 10
Setting of the contents of MBS interest indication

```
5.9.4.5 Setting of the contents of MBS Interest Indication
The UE may set the contents of the MBS Interest Indication as follows:
  1> if the UE has a valid version of SIB21 for the PCell; and
  1> if the set of MBS frequencies of interest for MBS broadcast reception on serving cells,
    determined in accordance with standard specification, is not empty:
    2> include mbs-FreqList and set it to include the MBS frequencies of interest sorted by
      decreasing order of interest, using the absoluteFrequencySSB for serving frequency,
      if applicable, and the ARFCN-ValueNR(s) as included in SIB21 or in USD (for
      neighbouring frequencies);
    2> include mbs-Priority if the UE prioritises reception of all indicated MBS frequencies
      above reception of any of the unicast bearers and multicast MRBs;
  NOTE 1: If the UE prioritises MBS broadcast reception and unicast/multicast data cannot
        be supported because of congestion on the MBS carrier(s), NG-RAN may for
        example initiate release of unicast bearers/multicast MRBs.
    2> if SIB20 is provided for the PCell or for the SCell:
      3> include mbs-ServiceList and set it to indicate the set of MBS services of interest
        sorted by decreasing order of interest determined in accordance with standard
        specification.
  NOTE 2: The mbs-ServiceList is not required to be used by the NG-RAN to determine
        the frequency on which to enable MBS broadcast reception for the UE.
  1> if nonServingCellMII is included in SIB1 for the PCell; and
  1> if the set of MBS frequencies for MBS broadcast reception on non-serving cells,
    determined in accordance with standard specification, is not empty:
    2> include the carrierFreqMBS, carrierBandwidth and subcarrierSpacing for MBS
      broadcast reception on the non-serving cell;
  1> else, if the set of MBS frequencies for MBS broadcast reception on non-serving cells,
    determined in accordance with 3GPP standard specification, becomes empty since the
    last transmission of the MBS Interest Indication including the list of MBS broadcast
    frequencies of interest for MBS broadcast reception on non-serving cell:
      2> include an empty container for NonServingInfo
```

TABLE 11
MBS interest indication message

```
MBSInterestIndication message
-- ASN1START
-- TAG-MBSINTERESTINDICATION-START
MBSInterestIndication-v18xy ::= SEQUENCE {
  mbs-NonServingInfo-r18 CarrierFreqListMBS-r18 OPTIONAL,
  lateNonCriticalExtension OCTET STRING OPTIONAL,
  nonCriticalExtension SEQUENCE { } OPTIONAL
}
-- TAG-MBSINTERESTINDICATION-STOP
-- ASN1STOP
```

mbs-NonServingInfo indicates the information for MBS broadcast reception on the non-serving cell. The UE signals an empty list (i.e., an empty container for mbs-NonServingInfo) to indicate that UE is no longer receiving or no longer interested to receive broadcast service on the previously reported frequencies on the non-serving cell.

The provided system 100 enables efficient approach for supporting shared processing for simultaneous MBS broadcast and unicast reception. The provided system 100 enables optimum configuration and higher data throughput performance for the UE 102 and the network 104.

The embodiments disclosed herein can be implemented through at least one software program running on at least one hardware device and performing network management functions to control the network elements. The modules and network elements shown in FIG. 1 include blocks which can be at least one of a hardware device, or a combination of hardware device and software module. The module as shown in FIG. 1 can be implemented as at least one of software or hardware.

The embodiment disclosed herein describes systems 100 and methods 200, 300, 400, 500, 600, and 700 for shared processing for simultaneous MBS broadcast and unicast reception which is important to enable optimum configuration and data throughput performance for the UE 102 and the network 104. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the present disclosure may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) supporting a multicast and broadcast services (MBS) in a wireless communication system, the method comprising:
receiving, from a primary cell (PCell) of a serving base station, a system information block (SIB) including information on a transmission of an MBS interest indication (MII) message for an MBS broadcast reception on a non-serving cell;
in case a MII message setting condition associated with the non-serving cell is satisfied, setting a content of the MII message; and
based on the information, transmitting, to the serving base station, the MII message.

2. The method of claim 1,
wherein the MII message setting condition associated with the non-serving cell is satisfied when:
an MBS broadcast frequency of an interest for the MBS broadcast reception on the non-serving cell is different from a MBS broadcast frequency of the interest for the MBS broadcast reception on the non-serving cell included in a last transmission of a MII, or
at least one a subcarrier spacing or common frequency resource (CFR) information for the MBS broadcast reception on the non-serving cell has change since the last transmission of the MII.

3. The method of claim 1, setting the content of the MII message comprising:
identifying whether an MBS frequency for an interest for an MBS broadcast reception on the non-serving cell is empty; and
in case that the MBS frequency for the interest for the MBS broadcast reception on the non-serving cell is not empty, including MBS frequency information of the non-serving cell in the MII message.

4. The method of claim 3, further comprising:
including CFR information and a subcarrier spacing for the MBS broadcast reception on the non-serving cell in the MII message.

5. The method of claim 1, further comprising:
wherein a frequency is considered as a MBS broadcast frequency of an interest for the MBS broadcast reception on the non-serving cell, in case that at least one MBS session the UE is receiving or interested to receive via a broadcast MBS radio bearer (MRB) is ongoing or about to start, the at least one of MBS session is associated with the non-serving cell, and a supported band combination list included in a UE-new radio (NR) capability contains at least one band combination including a concerned MBS frequency.

6. The method of claim 1,
wherein the transmission of the MII message is initiated when:
the UE changes to a PCell providing information on the transmission of the MII message for the MBS broadcast reception on the non-serving cell;
the UE starts to receive an MBS broadcast service on the non-serving cell;
the UE stops to receive the MBS broadcast service on the non-serving cell; or
at least one CFR information or a subcarrier spacing for the MBS broadcast reception on the non-serving cell is changed.

7. The method of claim 1, further comprising:
transmitting, to the serving base station, the MII message before receiving an MBS service on the non-serving cell.

8. A method performed by a serving base station supporting a multicast and broadcast services (MBS) in a wireless communication system, the method comprising:
transmitting, via a primary cell (PCell) of the serving base station to a user equipment (UE), a system information block (SIB) including information for configuring a user equipment (UE) to transmit an MBS interest indication (MII) message for an MBS broadcast reception on a non-serving cell; and
based on the information, receiving, from the UE, the MII message.

9. The method of claim 8,
wherein the MII message includes at least one MBS frequency information of the non-serving cell in the MII message, CFR information for the MBS broadcast reception on the non-serving cell, and a subcarrier spacing for the MBS broadcast reception on the non-serving cell.

10. The method of claim 8, further comprising:
receiving, from the UE, the MII message before transmitting an MBS service on the non-serving cell.

11. A user equipment UE supporting a multicast and broadcast services (MBS) in a wireless communication system, the UE comprising:
a transceiver; and
a controller configured to:
receive, from a primary cell (PCell) of a serving base station, a system information block (SIB) including information on a transmission of an MBS interest indication (MII) message for a MBS broadcast reception on a non-serving cell,
in case a MII message setting condition associated with the non-serving cell is satisfied, set a content of the MII message, and
based on the information, transmit, to the serving base station, the MII message.

12. The UE of claim 11,
wherein the MII message setting condition associated with the non-serving cell is satisfied when:
an MBS broadcast frequency of an interest for the MBS broadcast reception on the non-serving cell is different from a MBS broadcast frequency of the interest for the MBS broadcast reception on the non-serving cell included in a last transmission of a MII, or
at least one a subcarrier spacing or common frequency resource (CFR) information for the MBS broadcast reception on the non-serving cell has change since the last transmission of the MII.

13. The UE of claim 11, wherein the controller is further configured to:
identify whether an MBS frequency for an interest for a MBS broadcast reception on the non-serving cell is empty, and
in case that the MBS frequency for the interest for the MBS broadcast reception on the non-serving cell is not empty, include MBS frequency information of the non-serving cell in the MII message.

14. The UE of claim 11, wherein the controller is further configured to:
include CFR information and a subcarrier spacing for the MBS broadcast reception on the non-serving cell in the MII message.

15. The UE of claim 11,
wherein a frequency is considered as a MBS broadcast frequency of an interest for the MBS broadcast reception on the non-serving cell, in case that at least one MBS session the UE is receiving or interested to receive via a broadcast MBS radio bearer (MRB) is ongoing or about to start, the at least one of MBS session is associated with the non-serving cell, and a supported band combination list included in a UE-new radio (NR) capability contains at least one band combination including a concerned MBS frequency.

16. The UE of claim 11,
wherein the transmission of the MII message is initiated when:
the UE changes to a PCell providing information on the transmission of the MII message for the MBS broadcast reception on the non-serving cell;
the UE starts to receive an MBS broadcast service on the non-serving cell;
the UE stops to receive the MBS broadcast service on the non-serving cell; or
at least one CFR information or a subcarrier spacing for the MBS broadcast reception on the non-serving cell is changed.

17. The UE of claim 11, wherein the controller is further configured to:
transmit, to the serving base station, the MII message before receiving an MBS service on the non-serving cell.

18. A serving base station supporting a multicast and broadcast services (MBS) in a wireless communication system, the base station comprising:
a transceiver; and
a controller configured to:
transmit, via a primary cell (PCell) of the serving base station to a user equipment (UE), a system information block (SIB) including information for configuring a user equipment (UE) to transmit an MBS interest indication (MII) message for a MBS broadcast reception on a non-serving cell,
based on the information, receive, from the UE, the MII message.

19. The serving base station of claim 18,
wherein the MII message includes at least one MBS frequency information of the non-serving cell in the MII message, CFR information for the MBS broadcast reception on the non-serving cell, and a subcarrier spacing for the MBS broadcast reception on the non-serving cell.

20. The serving base station of claim 18, wherein the controller is further configured to:
receive, from the UE, the MII message before transmitting an MBS service on the non-serving cell.
